(19) United States
(12) Patent Application Publication
(10) Pub. No.: US 2017/0060564 A1
(43) Pub. Date: Mar. 2, 2017

(54) ELECTRONIC DEVICE AND METHOD

(71) Applicant: Kabushiki Kaisha Toshiba, Tokyo (JP)

(72) Inventor: Midori Nakamae, Hino Tokyo (JP)

(21) Appl. No.: 14/994,932

(22) Filed: Jan. 13, 2016

Related U.S. Application Data
(60) Provisional application No. 62/210,917, filed on Aug. 27, 2015.

(51) Int. Cl. G06F 9/445; H04L 29/08

(52) U.S. Cl. CPC G06F 8/65; H04L 67/34

(57) ABSTRACT

According to one embodiment, an electronic device includes a memory and a hardware processor. The hardware processor is coupled to the memory. The hardware processor is configured to obtain a difference file for updating a program, and apply the difference file to the program at a first time point at which the program is permitted to be updated after elapse of a first application delay time from issuance of the difference file or obtention of the difference file.

### CROSS-REFERENCE TO RELATED APPLICATIONS

This application claims the benefit of U.S. Provisional Application No. 62/210,917, filed Aug. 27, 2015, the entire contents of which are incorporated herein by reference.

### FIELD

Embodiments described herein relate generally to an electronic device and a method.

### BACKGROUND

Recent years have seen a rapid increase in damage caused to software users by computer viruses which attack via the vulnerability presented by security holes in software (programs), unauthorized access, etc. To reduce the security risk, the shortening of a vulnerable period from publication to application of a security patch is desired.

For example, in companies, in connection with a diversity of business systems, various types of software have been installed on client machines used by employees, such as personal computers. The required patch differs depending on the type of software. Thus, for example, it is difficult for a maintenance operative (operator) to select the patch to be applied to each client machine.

All of the published patches are preferably applied to all of the client machines to stably operate the client machines. However, some patches cause problems when they are applied to a client machine depending on the purpose of use of the client machine. Thus, the patch to be applied needs to be selected. However, when the number of client machines is large, the number of published patches is also large. In this manner, the selection of the patch to be applied is difficult. In consideration of these factors, a support tool for enabling the operator to effectively carry out tasks related to patches is required.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing an example of a form in which an electronic device provides an IT asset management service according to an embodiment.

FIG. 2 is an exemplary view showing an example of the system configuration of the electronic device according to the embodiment.

FIG. 3 is an exemplary view showing a functional block related to the patch application of the IT asset management service provision program executed on the electronic device according to the embodiment.

FIG. 4 is an exemplary view showing an example of the home screen provided by the IT asset management service provision program executed on the electronic device according to the embodiment.

FIG. 5 is an exemplary view showing an example of the patch application rule setting screen provided by the IT asset management service provision program executed on the electronic device according to the embodiment.

FIG. 6 is an exemplary view showing an example of the patch application rule selection screen provided by the IT asset management service provision program executed on the electronic device according to the embodiment.

FIG. 7 is an exemplary view showing an example of the patch application schedule setting screen provided by the IT asset management service provision program executed on the electronic device according to the embodiment.

FIG. 8 is an exemplary view for explaining an example of patch application timing control performed by the IT asset management service provision program executed on the electronic device according to the embodiment.

FIG. 9 is an exemplary flowchart showing the flow of patch application timing control performed by the IT asset management service provision program executed on the electronic device according to the embodiment.

FIG. 10 is an exemplary view showing an example of the patch-application-exclusion/individual-application-delay-time setting screen provided by the IT asset management service provision program executed on the electronic device according to the embodiment.

FIG. 11 is an exemplary view for explaining an example of automatic change of an application delay time by the IT asset management service provision program executed on the electronic device according to the embodiment.

FIG. 12 is an exemplary view for explaining another example of automatic change of application delay time by the IT asset management service provision program executed on the electronic device according to the embodiment.

### DETAILED DESCRIPTION

Various embodiments will be described hereinafter with reference to the accompanying drawings.

In general, according to one embodiment, an electronic device includes a memory and a hardware processor. The hardware processor is coupled to the memory. The hardware processor is configured to obtain a difference file for updating a program, and apply the difference file to the program at a first time point at which the program is permitted to be updated after elapse of a first application delay time from issuance of the difference file or obtention of the difference file.

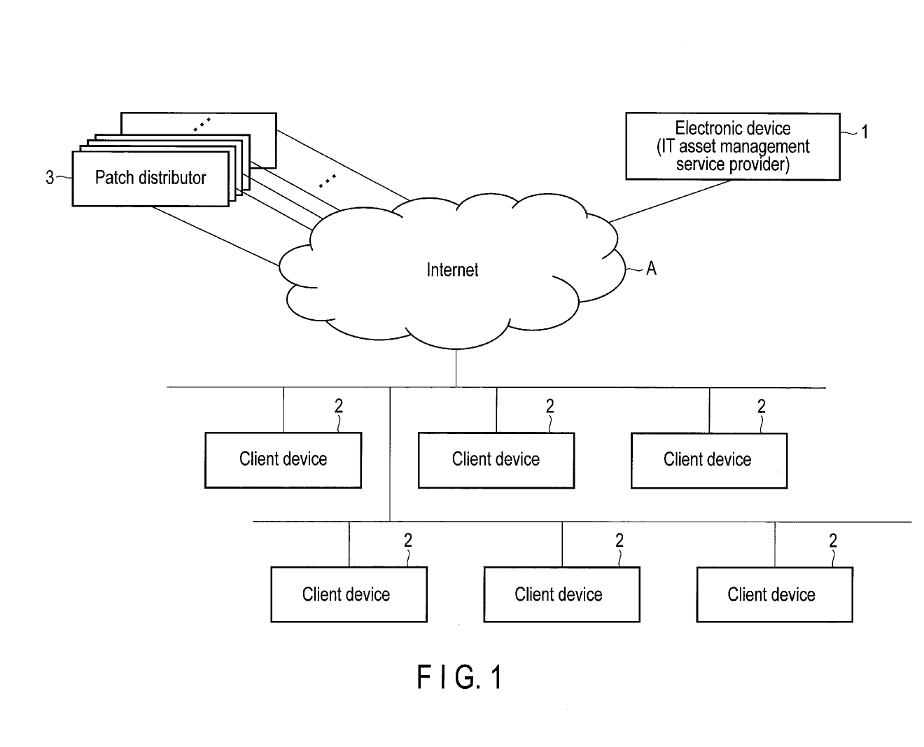

FIG. 1 is an exemplary view showing an example of a form in which an electronic device 1 provides an IT asset management service according to an embodiment. For example, the electronic device 1 provides supportive services via the Internet A such that a large number of client devices 2 used in a company can be effectively managed by the operator of the company. As one of the services, the electronic device 1 comprises a function for supporting a task related to a difference file (hereinafter, referred to as a patch) which is published with regard to software installed on the client devices 2 and is used to update the software. In the following description, this function is explained in detail.

A client module for an IT asset management service is installed on each client device 2. The client module is configured to transmit various types of information (for example, hardware information, software information and network information) related to each client device 2 to the electronic device 1 which is the provider of the IT asset management service. With the information from the client module, the electronic device 1 is capable of managing the software installed on the client devices 2 and the version of the software. The information from the client module includes information related to the operational state such as the number of accesses to a memory device such as a hard disk drive (HDD) or the number of errors. Based on the information, the electronic device 1 is capable of detecting a sign of trouble of various components in the client devices 2 and giving a warning to the operator (this is another service).

The electronic device 1 obtains a patch of software from a patch distributor 3 (for example, the website of the distributor of software) via the Internet A, for example. The electronic device 1 distributes the patch to the client devices 2 to which the patch should be applied at the appropriate time point described later based on the setting by the operator.

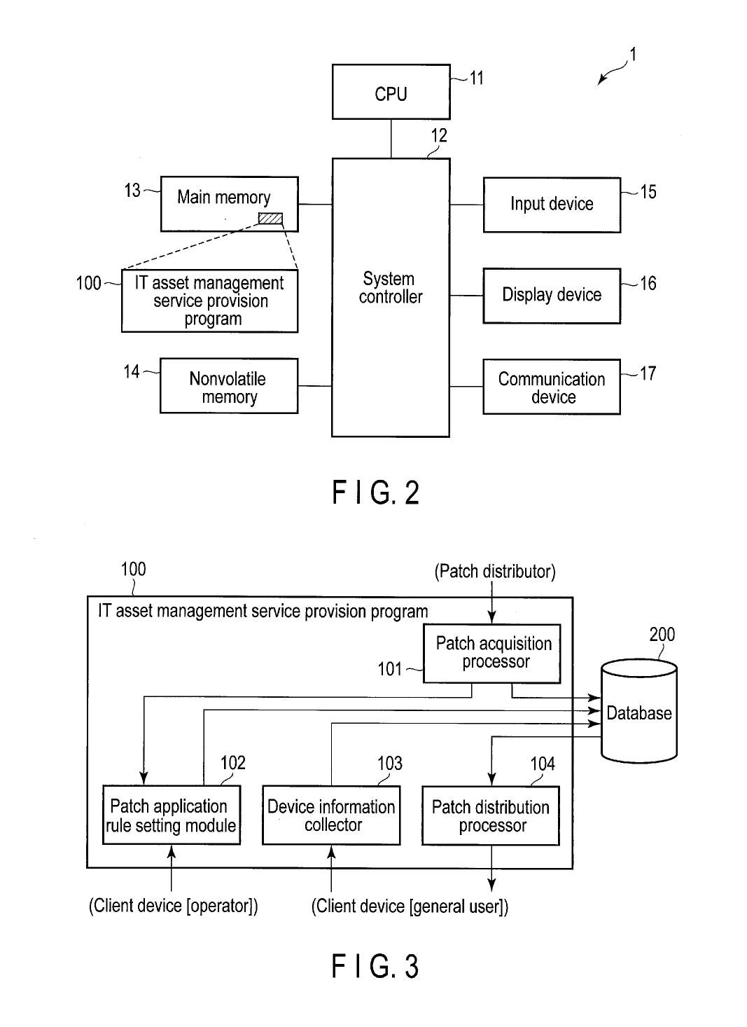

FIG. 2 shows an example of the system configuration of the electronic device 1.

As shown in FIG. 2, the electronic device 1 comprises a CPU 11, a system controller 12, a main memory 13, a nonvolatile memory 14, an input device 15, a display device 16, a communication device 17, etc.

The CPU 11 loads various programs for enabling the electronic device 1 to realize various functions from the nonvolatile memory 14 to the main memory 13, and executes the programs. One of the programs is an IT asset management service provision program 100 for allowing the electronic device 1 to operate to provide an IT asset management service. Both the main memory 13 and the nonvolatile memory 14 are storage devices for storing programs and data. The main memory 13 is a relatively high-speed small-capacity device which is dealt with as an internal memory device. The nonvolatile memory 14 is a relatively low-speed large-capacity device which is dealt with as an external memory device.

The system controller 12 is a bridge device which connects the CPU 11 and various components of the electronic device 1. Various controllers for controlling various components, such as a controller which controls the access to the nonvolatile memory 14, are incorporated into the system controller 12. The input device 15 is a device which handles the input of a user interface provided by the electronic device 1. The display device 16 is a device which handles the output of the user interface. The communication device 17 communicates with an external device (for example, the client devices 2 and the patch distributor 3) via, for example, the Internet A.

FIG. 3 shows a functional block related to the patch application of the IT asset management service provision program 100 executed on the electronic device 1 having the above system configuration.

As shown in FIG. 3, with regard to patch application, the IT asset management service provision program 100 comprises a patch acquisition processor 101, a patch application rule setting module 102, a device information collector 103, a patch distribution processor 104, etc.

The patch acquisition processor 101 accesses, for example, the website of the distributor (the patch distributor 3) of software at regular intervals and monitors whether or not a new patch is published. If a new patch is published, the patch acquisition processor 101 performs a process for obtaining the patch. The patch obtained by the patch acquisition processor 101 is stored in a database 200 constructed, for example, on the nonvolatile memory 14. With regard to patch acquisition, a request may be made in advance to the distributor of software such that a notification should be issued when a patch is published. In association with receipt of the notification, a process for obtaining the patch may be performed. Alternatively, a request may be made in advance to the distributor of software such that a patch should be transmitted when the patch is issued. In this manner, the patch may be passively obtained.

The patch application rule setting module 102 provides a user interface to allow the operator to set a rule for applying to the client devices 2 the patch which is obtained by the patch acquisition processor 101 and is stored in the database 200. The application rule is stored in the database 200. In the electronic device 1 of the present embodiment, the patch application rule setting module 102 is configured to set an application delay time from the issuance of a patch or the acquisition of a patch by the patch acquisition processor 101 to the application of the patch. The details of the patch application rule setting module 102 are described later (in particular, regarding the application delay time).

The device information collector 103 accumulates, in the database 200, the information which is obtained from the client module installed on each client device 2. The patch distribution processor 104 performs a process for transmitting a patch stored in the database 200 to the client devices 2 based on the application rule stored in the database 200. FIG. 3 shows only the modules for realizing functions related to patch application. However, the IT asset management service provision program 100 comprises other modules for realizing various functions including a function for authenticating the operator, for example.

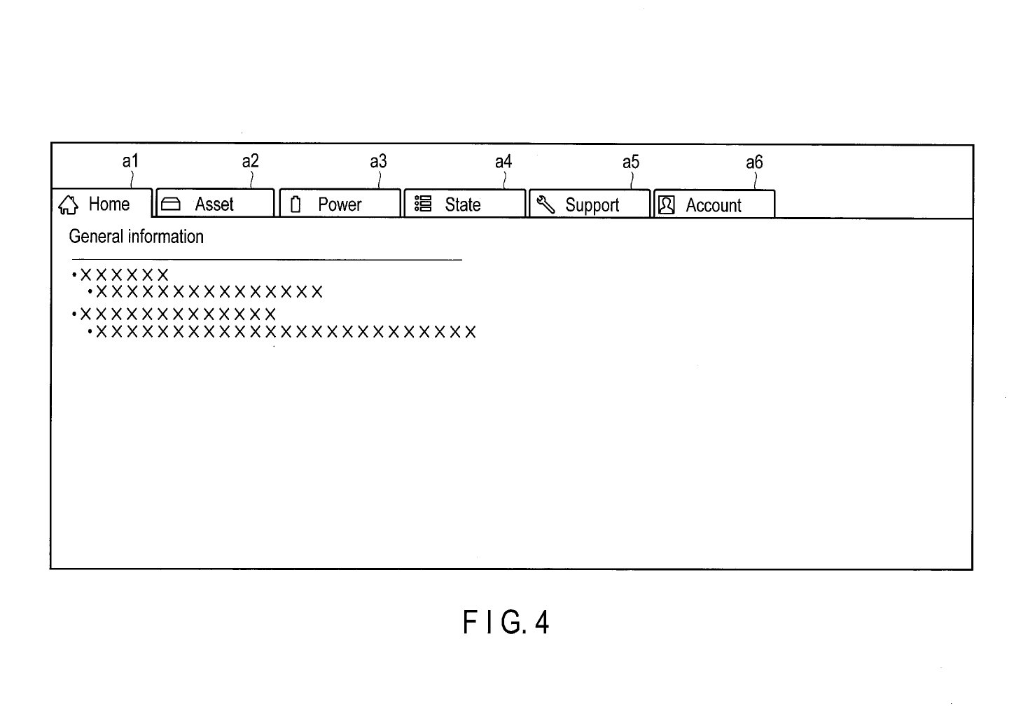

To set the application rule of a patch, the operator accesses the electronic device 1 through, for example, a web browser installed on the client device 2 (in other words, by specifying a predetermined URL). When the operator accesses the electronic device 1, a login screen requesting the input of, for example, a login ID or a password is displayed. If the operator logins with the valid values, a home screen is displayed as shown in FIG. 4, for example. In other words, if the IT asset management service provision program 100 approves login based on successful authentication with a login ID or a password, the IT asset management service provision program 100 transmits the web page for the home screen to the client device 2. Each screen for the IT asset management service displayed on the client device 2 used by the operator is displayed by the web browser on the client device 2 based on the web page provided by the IT asset management service provision program 100 on the electronic device 1. The data (including operation information) input to each screen is transmitted to the IT asset management service provision program 100 of the electronic device 1 by the web browser on the client device 2.

As shown in FIG. 4, the home screen includes, for example, a home tag a1, an asset tag a2, a power tag a3, a state tag a4, a support tag a5 and an account tag a6. The operator is able to display a screen related to patch application by clicking the state tag a4 with a pointing device such as a mouse.

The home tag a1 is a tag for displaying the home screen when another screen is displayed. For example, notifications are described on the home screen. The device information and software information of the client device 2 can be checked by clicking the asset tag a2. Further, setting may be performed to group the client devices 2 for management. When the power tag a3 is clicked, changes in power consumption and the prediction of electric power charge of the client device 2 can be checked, and further, peak-shift setting can be performed. Peak-shift setting is performed to switch the power operation between a battery and an AC adapter depending on the period and prevent the power consumption from the AC adapter in a period having a large amount of power consumption (in short, a peak time). For example, the license can be confirmed by clicking the support tag a5. For example, contract information can be confirmed by clicking the account tag a6.

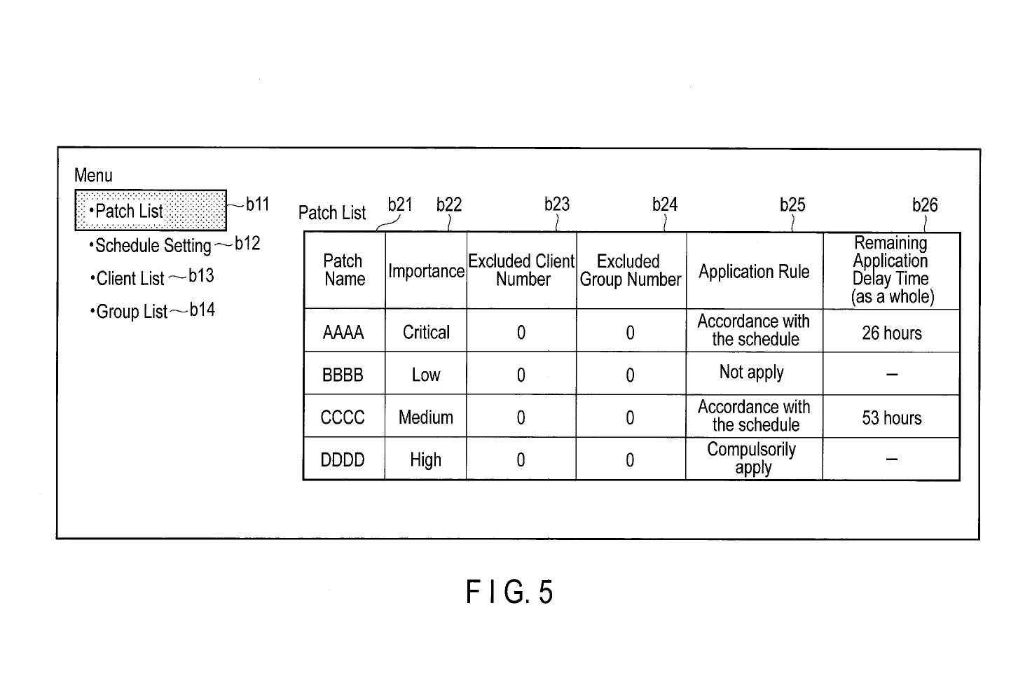

FIG. 5 is an exemplary view showing an example of the patch application rule setting screen displayed by clicking the state tag a4.

As shown in FIG. 5, the patch application rule setting screen includes, for example, a patch list menu b11, a schedule setting menu b12, a client list menu b13 and a group list menu b14. When the patch list menu b11 is selected, the list of patches stored in the database 200 is displayed. FIG. 5 shows an example of the patch application rule setting screen on which the list of patches is displayed.

As shown in FIG. 5, the patches stored in the database 200 are displayed in the list of patches in a state where information is allocated in each of, for example, a patch name field b21, an importance field b22, an excluded client number field b23, an excluded group number field b24, an application rule field b25 and a remaining application delay time field b26.

First, the application rule is explained. As shown in FIG. 5, the application rule includes three types of options which are “accordance with the schedule”, “not apply” and “compulsorily apply”. In the option “accordance with the schedule”, the time point for applying the patch to the client device 2 is controlled based on the patch application schedule set by the operator. The patch application schedule can be set on the patch application schedule setting screen which is displayed when the schedule setting menu b12 is selected as described later. In the option “not apply”, the patch is not applied to the client device 2. In the option “compulsorily apply”, the patch application to the client device 2 is immediately started. The default of the application rule is set to “accordance with the schedule”. Thus, when a new patch is obtained by the patch acquisition processor 101, the patch application rule setting module 102 sets the application rule of the patch to “accordance with the schedule”.

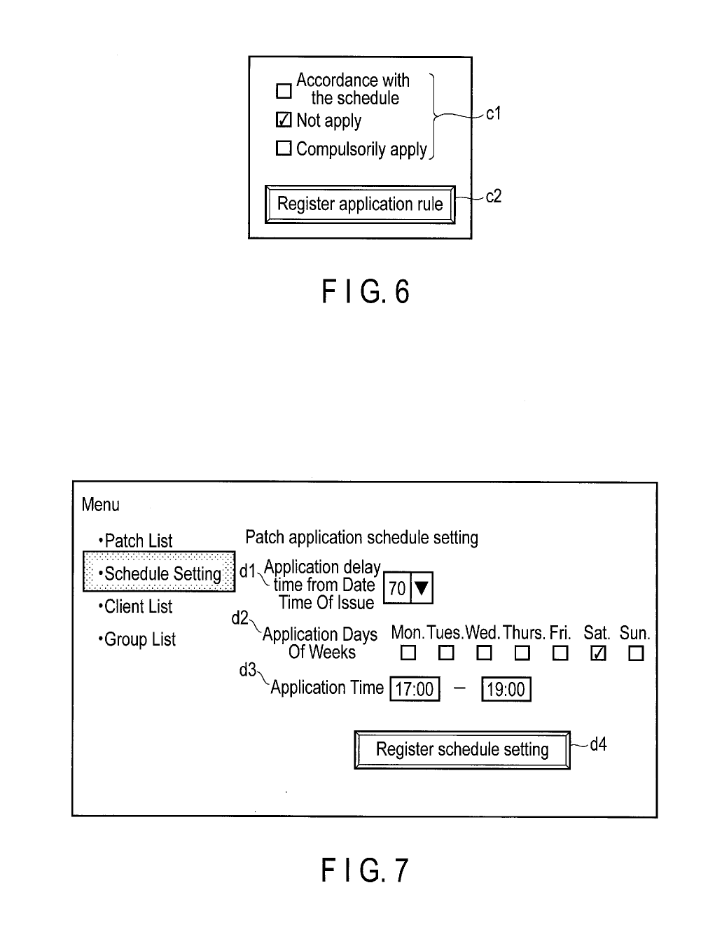

If the operator wants to change the application rule of a patch from the default “accordance with the schedule” to the option “not apply”, for example, the operator clicks the area inside the application rule field b25 of the patch, in short, the area in which the option “accordance with the schedule” is displayed. In this manner, the patch application rule selection screen exemplarily shown in FIG. 6 is displayed.

As shown in FIG. 6, the patch application rule selection screen includes a button c1 for selecting one of the above options “accordance with the schedule”, “not apply” and “compulsorily apply”. It is possible to change the application rule from “accordance with the schedule” to “not apply” by selecting “not apply” with the button c1 and clicking a registration button c2. In other words, the patch application rule setting module 102 changes the application rule in accordance with the operation on the patch application rule selection screen. When the operator wants to immediately apply a patch to the client device 2, the operator shall change the application rule from “accordance with the schedule” or “not apply” to “compulsorily apply” on the patch application rule selection screen.

FIG. 7 is an exemplary view showing an example of the patch application schedule setting screen which is displayed when the schedule setting menu b12 (see FIG. 5) is selected.

As shown in FIG. 7, the patch application schedule setting screen includes an application delay time setting area d1, an application day setting area d2 and an application time setting area d3. In the example of FIG. 7, the application delay time from date time of issue is set to 70 hours. The application days of weeks is set to Saturday. The application time is set to 17:00 to 19:00. A plurality of application days may be set. When a registration button d4 is clicked, the setting on the patch application schedule setting screen can be determined. In other words, the patch application rule setting module 102 changes the patch application schedule in accordance with the operation on the patch application schedule setting screen. The application day and the application time are used to specify the appropriate time point for updating software (in other words, the time point at which software is permitted to be updated), and are considered as common setting items. In addition to these items, the application delay time from date time of issue is employed as a setting item in the electronic device 1 (the IT asset management service provision program 100) of the embodiment.

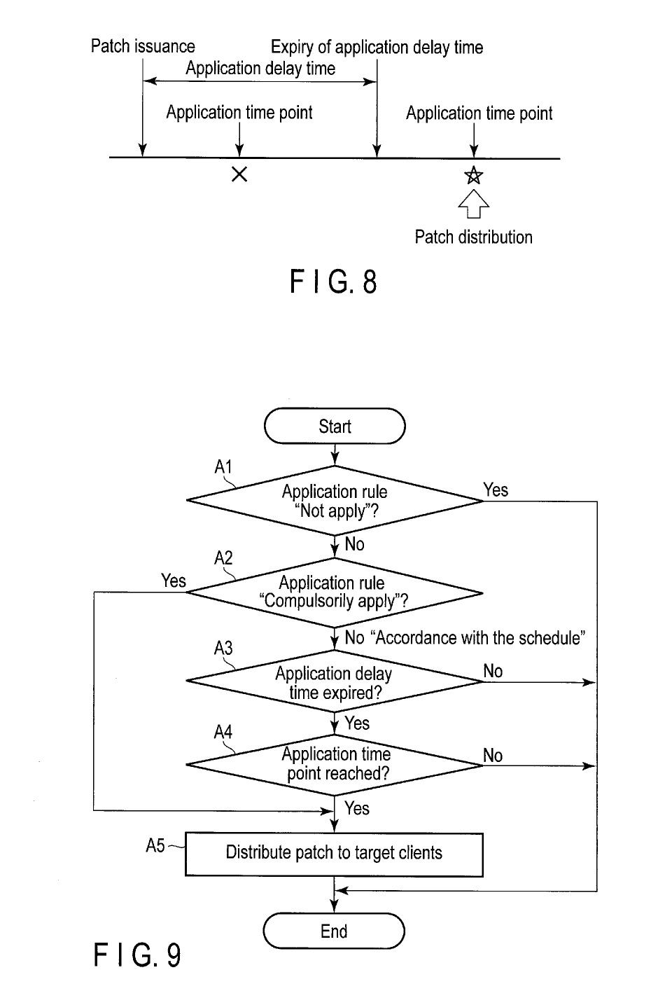

With reference to FIG. 8, this specification explains how the patch application time set to “accordance with the schedule” as the application rule is controlled by the patch application schedule including the application delay time unique to the electronic device 1 (the IT asset management service provision program 100) of the present embodiment.

This specification assumes a first comparison example in which the application delay time is not present as a setting item of the patch application schedule. In a manner similar to that of the example shown in FIG. 7, the application days of weeks is assumed to be set to Saturday. The application time is assumed to be set to 17:00 to 19:00. In this assumption, for example, the patch of software is issued at 13:00 on Saturday. Here, the application delay time is explained based on the issuance time of the patch (by the patch distributor 3). However, the application delay time may be based on the acquisition time of the patch (by the electronic device 1).

In this case, (if the default of the application rule is set to “accordance with the schedule”), only four hours are left from the issuance of the patch until the application start of the patch. It is difficult for the operator to determine, in this short period, whether or not the patch should be applied and whether or not a client device 2 to be excluded from application is present.

Now, this specification assumes a second comparison example in which the default of the application rule is set to “not apply”. In other words, a patch is applied substantially by hand based on the instruction of the operator. In this case, or even in the first comparison example, if the application is postponed until 17:00 to 19:00 on the next Saturday, it is possible to ensure the time for enabling the operator to determine whether or not the patch should be applied. However, the operator may forget changing the application rule from “not apply” to “accordance with the schedule” or “compulsorily apply” although the patch should be applied. Thus, the software may be continuously used without application of the patch.

Compared with this, in the electronic device 1 (the IT asset management service provision program 100) of the embodiment, the application delay time is employed as a new setting item of the patch application schedule. In this electronic device 1, even in the case of the first comparison example, the operator can have the time to determine whether or not the patch should be applied. Thus, it is possible to prevent trouble caused by the application of an unnecessary patch. Further, it is possible to certainly apply a necessary patch.

More specifically, as shown in FIG. 8, even if the application time point (17:00 on Saturday in the example shown in FIG. 7) determined as the application day and the application time has been reached within the application delay time from the issuance of the patch, the patch distribution processor 104 of the IT asset management service provision program 100 does not transmit the patch to the client device 2. The patch distribution processor 104 transmits the patch to the client device 2 at the application time point after the application delay time expires. In other words, the time for allowing the operator to determine whether or not the patch should be applied is ensured by the period set as the application delay time (70 hours in the example shown in FIG. 7). Further, the patch is certainly applied.

FIG. 5 is referred to again.

As shown in FIG. 5, with regard to each patch whose application rule is set to “accordance with the schedule”, the remaining application delay time field b26 in the list of patches indicates a value obtained by subtracting the elapsed time from the issuance of the patch from the application delay time. In the list of patches, the arrangement order may be changed to ascending order of values indicated in the remaining application delay time field b26. Thus, the operator is able to determine whether or not each patch should be applied in order from the patch in which the expiry of the application delay time is the closest. In the list of patches, the arrangement order may be changed to descending order of importance indicated in the importance field b22.

FIG. 9 is an exemplary flowchart showing the flow of patch application timing control by the electronic device 1 (the IT asset management service provision program 100) of the embodiment.

When the application rule set by the patch application rule setting module 102 indicates “not apply” (Yes in block A1), the patch distribution processor 104 does not apply the patch and terminates the process for the patch. When the application rule indicates “compulsorily apply” (No in block A1 and Yes in block A2), the patch distribution processor 104 immediately starts the application of the patch (block A5).

When the application rule indicates “Accordance with the schedule” (No in block A2), the patch distribution processor 104 examines whether or not the application delay time set by the patch application rule setting module 102 has expired (block A3). When the application delay time has not expired (No in block A3), the patch distribution processor 104 does not apply the patch and terminates the process for the patch. When the application delay time has expired (Yes in block A3), the patch distribution processor 104 examines whether or not the application day and the application time set by the patch application rule setting module 102 have been reached, in other words, whether or not the patch application time point has been reached (block A4). When the patch application time point has not been reached (No in block A4), the patch distribution processor 104 does not apply the patch and terminates the process for the patch. When the patch application time point has been reached (Yes in block A4), the patch distribution processor 104 starts the application of the patch (block A5).

In this manner, in the electronic device 1 (the IT asset management service provision program 100) of the embodiment, the application delay time is set as a new setting item of the patch application schedule. This electronic device 1 is able to support the operator to effectively perform tasks related to patches.

The patch application rule setting module 102 can exclude each client device 2 from the application of a patch or individually set the application delay time for each client device 2. Moreover, it is possible to exclude each group including a plurality of client devices 2 from the application of a patch or individually set the application delay time for each group including a plurality of client devices 2. A group may be prepared by hand when the operator clicks the asset tag a2 shown in FIG. 4. A group may be automatically prepared by the IT asset management service provision program 100 based on the information which is accumulated in the database 200 by the device information collector 103, which is obtained from the client module installed on the client device 2.

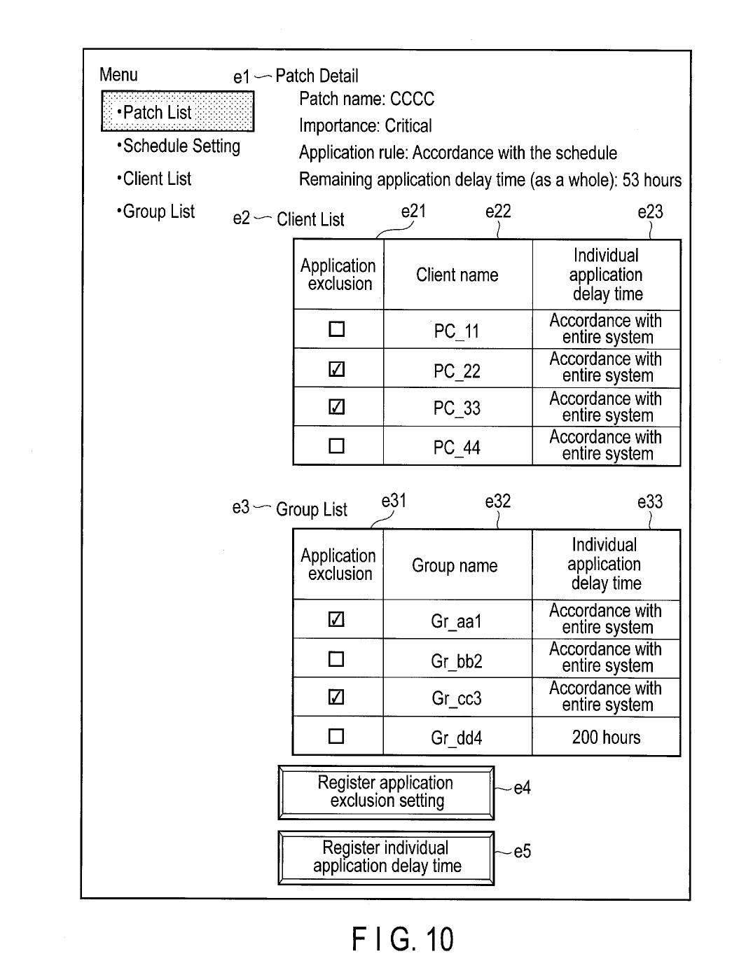

For example, when the operator wants to individually set the application delay time of each client device 2 with respect to one of a plurality of patches displayed in the list of patches shown in FIG. 5, the operator clicks the patch name field b21 of the patch. In this manner, the patch-application-exclusion/individual-application-delay-time setting screen exemplarily shown in FIG. 10 is displayed.

As shown in FIG. 10, the patch-application-exclusion/individual-application-delay-time setting screen includes a first area e1 for displaying the details of a patch, a second area e2 for displaying a list of clients and a third area e3 for displaying a list of groups. In the list of clients in the second area e2, the client devices 2 containing the software to which the patch should be applied are displayed in a state where information is allocated in each of, for example, an application exclusion field e21, a client name field e22 and an individual application delay time field e23.

In the individual application delay time field e23, the display “accordance with entire system” indicates the default in which the individual application delay time is not set. When the operator wants to set the individual application delay time for a client device 2, the operator inputs a desired value (time) to the individual application delay time field e23 and clicks a registration button e5. When the operator wants to exclude a client device 2 from the application of the patch, the operator shall turn on the button in the application exclusion field e21 and click a registration button e4. The number of client devices 2 excluded from the application is displayed in the excluded client number field b23 when the list of patches is displayed as shown in FIG. 5.

Similarly, in the list of groups in the third area e3, the groups including client devices 2 containing the software to which the patch should be applied are displayed in a state where information is allocated in each of, for example, an application exclusion field e31, a group name field e32 and an individual application delay time field e33. When the operator wants to set the individual application delay time for a group, the operator inputs a desired value (time) to the individual application delay time field e33 and clicks the registration button e5. When the operator wants to exclude a group from the application of the patch, the operator shall turn on the button in the application exclusion field e31 and click the registration button e4. The number of groups excluded from the application is also displayed in the excluded group number field b24 when the list of patches is displayed as shown in FIG. 5.

Thus, in the electronic device 1 (the IT asset management service provision program 100) of the embodiment, it is possible to plan the patch application in more detail for each client device 2 or each group.

The patch application rule setting module 102 can automatically change the application delay time of a patch based on, for example, the importance of the patch.

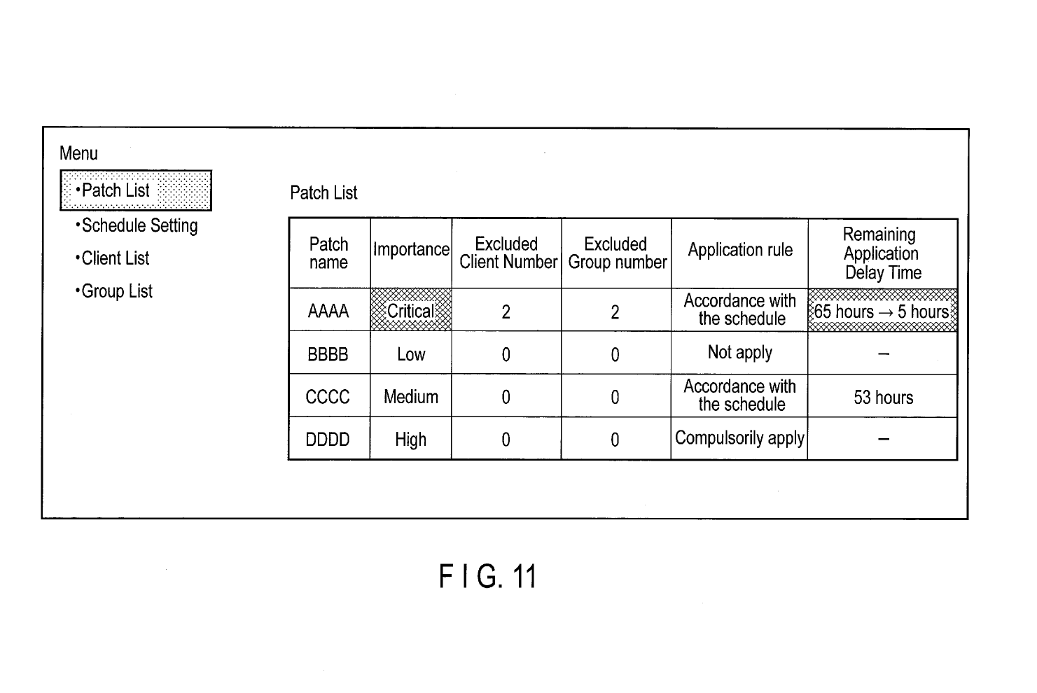

For example, when the importance of a patch is high, there is a high possibility that the security risk of the patch is high. Thus, the patch should be applied as soon as possible. The patch application rule setting module 102 automatically changes the application delay time from the time set by the operator to a shorter time in order to enable the operator to prioritize the determination of the application of the patch. In the example of FIG. 11, since the patch having a patch name of “AAAA” has the highest importance (“critical”), the application delay time is automatically changed from 70 hours to 10 hours. Thus, when the list of patches is displayed 5 hours after the issuance of the patch, the remaining application delay time indicates 5 hours although it indicates 65 hours in a normal case. In general, the operator determines whether or not a patch should be applied in ascending order of the remaining application delay time. Therefore, if the application delay time is changed in this manner, it is possible to guide the operator so as to preferentially begin with the process related to a patch having a high importance.

Apart from the importance of a patch, for example, the application delay time of a patch can be automatically changed based on the following principles.

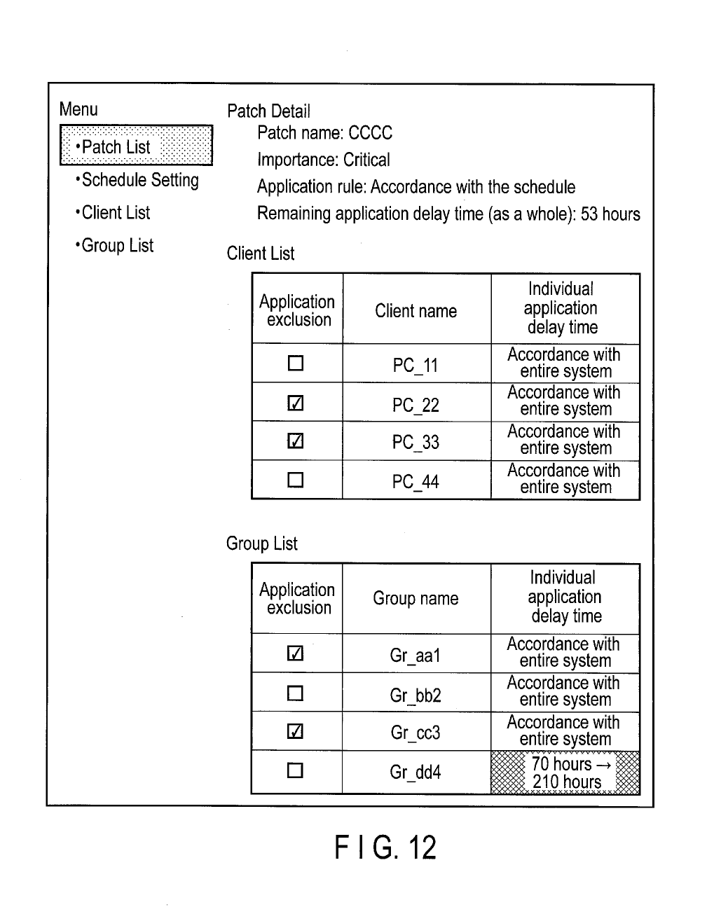

The IT asset management service provision program 100 automatically prepares a group of client devices 2 based on the history of patch application in the past. For example, if a group of client devices 2 excluded from the application of a patch of software was prepared in the past, there is a high possibility that a patch of the software is not applied to the group. Therefore, even if the application delay time of the group is extended from the time set by the operator when a patch of the software is issued, there is a low possibility that a problem occurs. In the example of FIG. 12, the individual application delay time for the group having a group name of “Gr_dd4” including client devices 2 containing the software which is the application target of the patch having a patch name of “CCCC” is automatically changed from 70 hours to 210 hours. Thus, the process related to a low-priority patch for a group is left until later. In this manner, it is possible to guide the operator so as to preferentially begin with the process related to a high-priority patch.

The patch application rule setting module 102 may individually set the application delay time for each patch which is obtained by the patch acquisition processor 101 and is stored in the database 200.

In the above explanation, the electronic device 1 manages patch application for the software installed on the client devices 2 connected via the network A as an IT asset management service. However, the method for managing patch application in consideration of the application delay time is not limited to this example. For example, it is possible to manage patch application for the software installed on the self device (the electronic device 1).

Each of the functions described in the present embodiment may be realized by a processing circuit (hardware processor). For example, the processing circuit includes a programmed processor such as a central processing unit (CPU). The processor performs each of the functions described above by executing a program stored in a memory. The processor may be a microprocessor including an electric circuit. For example, the processing circuit includes a digital signal processor (DSP), an application specific integrated circuit (ASIC), a microcontroller, a controller and other electric circuit components.

Since each process of the present embodiment can be implemented by a computer program, advantages similar to those of the present embodiment can easily be obtained by merely installing the computer program on a normal computer via a computer-readable storage medium in which the computer program is stored, and executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a memory; and
a hardware processor coupled to the memory, and configured to:
obtain a difference file for updating a program; and
apply the difference file to the program at a first time point at which the program is permitted to be updated after elapse of a first application delay time from issuance of the difference file or obtention of the difference file.

2. The electronic device of claim 1, wherein the hardware processor is configured to set the first application delay time.

3. The electronic device of claim 2, wherein:
the program is installed on a client device connected with the electronic device via a network; and
the hardware processor is configured to set the first application delay time for each client device.

4. The electronic device of claim 2, wherein:
the program is installed on a client device connected with the electronic device via a network; and
the hardware processor is configured to set the first application delay time for each group comprising a plurality of client devices.

5. The electronic device of claim 2, wherein the hardware processor is configured to set the first application delay time for each obtained difference file.

6. The electronic device of claim 1, wherein the hardware processor is configured to change the first application delay time in accordance with importance or application history of the difference file.

7. The electronic device of claim 1, wherein the hardware processor comprises means for applying the difference file to the program at the first time point at which the program is permitted to be updated after elapse of the first application delay time from issuance of the difference file or obtention of the difference file.

8. A method of an electronic device, the method comprising:
obtaining a difference file for updating a program; and
applying the difference file to the program at a first time point at which the program is permitted to be updated after elapse of a first application delay time from issuance of the difference file or obtention of the difference file.

9. The method of claim 8, further comprising setting the first application delay time.

10. The method of claim 9, wherein the setting comprises setting the first application delay time for each client device connected with the electronic device via a network.

11. The method of claim 9, wherein the setting comprises setting the first application delay time for each group comprises a plurality of client devices connected with the electronic device via a network.

12. The method of claim 9, wherein the setting comprises setting the first application delay time for each of the obtained difference files.

13. The method of claim 8, further comprising changing the first application delay time in accordance with importance or application history of the difference file.
